(19) United States
(12) Patent Application Publication
(10) Pub. No.: US 2022/0240612 A1
(43) Pub. Date: Aug. 4, 2022

(54) KNITTED FABRIC AND MAKING METHOD THEREFOR, DEVICE USED, AND CLOTHING MADE THEREFROM

(71) Applicant: LUTHAI TEXTILE CO., LTD., Shandong (CN)

(72) Inventors: Deming LIU, Shandong (CN); Jiabin WANG, Shandong (CN); Jianhao JIN, Shandong (CN); Min ZHANG, Shandong (CN); Daoxi YANG, Shandong (CN); Yan WANG, Shandong (CN); Haiyan SONG, Shandong (CN); Yunhui JIA, Shandong (CN); Faqiang SONG, Shandong (CN); Min WANG, Shandong (CN); Fang HAN, Shandong (CN)

(21) Appl. No.: 17/437,036

(22) PCT Filed: Jul. 12, 2019
(86) PCT No.: PCT/CN2019/095895

§ 371 Date: Apr. 18, 2022

(30) Foreign Application Priority Data
Jun. 28, 2019 (CN) 201910576935.7

(51) Int. Cl. A41D 31/04; D06M 11/61

(52) U.S. Cl. CPC A41D 31/04; A41D 2500/10; D06M 11/61

(57) ABSTRACT

Disclosed is a knitted fabric containing natural fibers and a making method therefor, a liquid ammonia device and a shirt made from the knitted fabric, belonging to the fields of fabrics and clothing. The making method for the knitted fabric containing natural fibers comprises forming yarns containing natural fibers into a knitted fabric by a fabric-knitting method; and performing functional finishing including a liquid ammonia finishing procedure on the knitted fabric. In the liquid ammonia finishing procedure, liquid ammonia impregnation is performed on the knitted fabric at least twice under the condition of mechanical restraint by a guide roller set, thus preventing the knitted fabric from edge curling due to strong shrinkage in the liquid ammonia impregnation process, enabling the knitted fabric to be subjected to sufficient and uniform liquid ammonia impregnation, ensuring the liquid ammonia impregnation effect and controlling the shrinkage rate of the knitted fabric; and through subsequent shaping and finishing procedures, the color stability of the knitted fabric is further improved, the shrinkage rate after washing is reduced, and the crease-resistant performance and resilience performance are improved. The shirt has a low shrinkage rate after washing, good stiffness performance, good resilience performance, color stability, high strength and good crease-resistant performance.

### TECHNICAL FIELD

The present application relates to a knitted fabric and a making method therefor, a device used and a clothing made therefrom, in particular to a knitted fabric containing natural fibers and a making method therefor, a used liquid ammonia device and a shirt made from the knitted fabric, and belongs to the fields of fabrics and clothing.

### BACKGROUND ART

A knitted fabric has the characteristics of high elasticity and wearing comfort, but has great limitations on stiffness performance, size stability and shrinkage. After the knitted fabric is made into clothing, worn for a period of time and washed with water for several times, the deformation is generally serious, the appearance of the clothing is influenced, and the requirements of business shirts cannot be met particularly. Additionally, the knitted fabric produced by a traditional process is not bright enough in gloss and not soft enough in hand feeling, although the gloss is good after mercerisation finishing by caustic soda, the hand feeling becomes hard and rough, the use performance of the knitted fabric is influenced to a certain extent, and the product grade seems not high.

Liquid ammonia mercerisation is a finishing processing mode capable of maximising the inherent performance of an original fabric. Liquid ammonia mercerisation is a finishing process which can not only not influence the softness, water absorption performance and moisture absorption performance of the original fabric, but also improve the crease-resistant performance at the same time. The anhydrous liquid ammonia has small molecule, low viscosity and high permeability to natural fibers, when the liquid ammonia molecule enters the insides of the natural fibers, the natural fibers naturally retract, the molecules are rearranged, the original internal stress is eliminated, the cross section of the natural fibers is more elliptical, the size stability of the fabric is improved, the color saturation degree, the smoothness and the elasticity are high, and this method is a finishing method for processing the natural fiber fabric faster, more uniformly and more effectively.

Liquid nitrogen mercerisation of an existing woven fabric is continuously performed in a sealed machine system. Below a temperature of −33° C., the ammonia molecules are liquified and then enter the insides of tensioned natural fibers such as cotton fibers, and next, the ammonia is recovered inside a sealed machine in a temperature rise gasification mode. The woven fabric per se is tightly flattened and spread, the knitted fabric has high elasticity, strong shrinkage of the knitted fabric can be easily caused by continuous liquid ammonia finishing, deformation is very easy to occur after warp stretching, and warp shrinkage is very great. Meanwhile, the fabric edge of the knitted fabric, particularly, the weft knitted fabric has the natural edge curling tendency, by using a continuous sealed liquid ammonia mercerisation machine for treatment, the problems of crease marks existing in the middle of the fabric, serious edge curling and serious press marks can easily occur, and the product quality of the fabric is seriously influenced. The partial liquid ammonia device is provided with a spreading adjuster before entering a liquid ammonia tank and after leaving the liquid ammonia tank to solve the problem of edge curling of the knitted fabric. However, the effect on preventing the edge curling of the knitted fabric is limited, and the strong shrinkage of the fabric width of the knitted fabric during liquid ammonia impregnation and the liquid ammonia impregnation uniformity cannot be controlled. The existing continuous liquid ammonia devices and liquid ammonia impregnation finishing methods have parts to be improved in industrialised application industry of weaving of the knitted fabrics. Additionally, the knitted fabric finished by the liquid ammonia will optimise partial performance of the knitted fabric, but may reduce performance in aspects such as strength, so that the specific preparation procedure such as a special yarn dyeing procedure needs to be developed by aiming at the knitted fabric subjected to liquid ammonia finishing.

### SUMMARY OF THE INVENTION

In order to solve the above problems, the present application provides a knitted fabric containing natural fibers and a making method therefor, a liquid ammonia device and a shirt made from the knitted fabric. A making method for the knitted fabric containing natural fibers comprises: forming yarns containing natural fibers into a knitted fabric by a fabric-knitting method; and performing functional finishing including a liquid ammonia finishing procedure on the knitted fabric. In the liquid ammonia finishing procedure of the present application, liquid ammonia impregnation is performed on the knitted fabric at least twice under the condition of mechanical restraint by a guide roller set, thus preventing the knitted fabric from edge curling due to strong shrinkage in the liquid ammonia impregnation process, enabling the knitted fabric to be subjected to sufficient and uniform liquid ammonia impregnation, ensuring the liquid ammonia impregnation effect and controlling the shrinkage rate of the knitted fabric; and through subsequent shaping and finishing procedures, the color stability of the knitted fabric is further improved, the shrinkage rate after washing is reduced, and the crease-resistant performance and resilience performance are improved. The shirt of the present application has a low shrinkage rate after washing, good stiffness performance, good resilience performance, color stability, high strength and good crease-resistant performance.

The making method for the knitted fabric containing natural fibers comprises:

forming yarns containing natural fibers into a knitted fabric by a fabric-knitting method, and performing functional finishing including a liquid ammonia finishing procedure on the knitted fabric, wherein the liquid ammonia finishing procedure comprises:

1) adjusting a moisture content of the knitted fabric to be below 10%;

2) performing liquid ammonia impregnation on the knitted fabric obtained in step 1) at least twice in a liquid ammonia impregnation tank through a guide roller set, enabling the knitted fabric to maintain mechanical restraint at least between an inlet of the liquid ammonia impregnation tank and an outlet of the liquid ammonia impregnation tank, enabling the knitted fabric finishing being subjected to liquid ammonia impregnation to pass through a roller to extrude excessive ammonia from the knitted fabric, and controlling the liquid ammonia impregnation quantity to be 45% to 75% of the dry weight of the knitted fabric; and

3) removing ammonia from the knitted fabric obtained in step 2) through evaporation to obtain the knitted fabric. Through at least two-time liquid ammonia impregnation performed on the knitted fabric, the liquid ammonia impregnation is more uniformly performed on the knitted fabric, and an liquid ammonia impregnation effect is better.

Optionally, excessive ammonia is extruded through the roller, and the liquid ammonia impregnation quantity is controlled to be 50% to 70% of the dry weight of the knitted fabric.

Optionally, the guide roller set is disposed between the inlet of the liquid ammonia impregnation tank and the outlet of the liquid ammonia impregnation tank.

Preferably, the guide roller set comprises continuously disposed guide rollers. By using the arrangement mode of the guide roller set, the knitted fabric maintains fabric conveyance between the guide rollers before, during and after liquid ammonia impregnation, the edge curling of the knitted fabric and the weft strong shrinkage of the knitted fabric are effectively prevented, and the radial tension is effectively controlled.

More preferably, at least a surface of each of the guide rollers is made of an elastic material. Further, the surface of the guide roller is covered with at least one of rubber, sponge and resin materials. The elastic material covering the surface of the guide roller can enable the knitted fabric to be subjected to sufficient and uniform liquid ammonia impregnation.

Optionally, a first spreading roller is disposed at an upstream side of the inlet of the liquid ammonia impregnation tank, a second spreading roller is disposed at a downstream side of the outlet of the liquid ammonia impregnation tank, and/or a third spreading roller is disposed at a downstream side of the roller. Through the arrangement of the spreading rollers, the weft strong shrinkage and caused edge curling of the knitted fabric are further prevented.

Optionally, at least the knitted fabric between the inlet of the liquid ammonia impregnation tank and the third spreading roller maintains the mechanical restraint. Preferably, at least the knitted fabric between the inlet of the liquid ammonia impregnation tank and the third spreading roller passes through the guide roller set. More preferably, the guide roller set comprises continuously disposed guide rollers. After the knitted fabric goes out of the liquid ammonia impregnation tank, the fabric contains liquid ammonia, and will also generate a shrinkage phenomenon. By using such an arrangement mode, the edge curling and weft strong shrinkage of the knitted fabric are further prevented, and the radial tension is effectively controlled.

Optionally, the guide roller set comprises a direction-guiding roller set and a liquid ammonia impregnation roller set disposed between the inlet of the liquid ammonia impregnation tank and the outlet of the liquid ammonia impregnation tank; the direction-guiding roller set comprises an inlet direction-guiding roller pair, an ammonia leaving direction-guiding roller and an outlet direction-guiding roller pair; the liquid ammonia impregnation roller set comprises a first liquid ammonia impregnation roller and a second liquid ammonia impregnation roller; and the knitted fabric is subjected to first-time liquid ammonia impregnation through the first liquid ammonia impregnation roller of the liquid ammonia impregnation tank after passing through the inlet direction-guiding roller pair, then goes out of the liquid ammonia impregnation tank through the ammonia leaving direction-guiding roller, is next subjected to second-time liquid ammonia impregnation through the second liquid ammonia impregnation roller, and finally finishes being subjected to the liquid ammonia impregnation after passing through the outlet direction-guiding rollers. The inlet direction-guiding roller pair comprises two mutually cooperating inlet direction-guiding rollers, and the outlet direction-guiding roller pair comprises two mutually cooperating outlet direction-guiding rollers. By using such an arrangement mode, the knitted fabric is enabled to maintain fabric conveyance between the guide rollers before entering the liquid ammonia impregnation tank, during liquid ammonia impregnation and after going out of the liquid ammonia impregnation tank when liquid ammonia impregnation is finished, the edge curling of the knitted fabric is completely avoided, and the shrinkage rate of the knitted fabric is effectively controlled. Further, at least the surface of each of the guide rollers is made of the elastic material, so that the uniform liquid ammonia impregnation effect of the knitted fabric is further ensured.

Optionally, the radial tension of the knitted fabric passing through the liquid ammonia impregnation tank and the roller is set to be first tension, and the first tension is 75 N to 100 N. Further, a lower limit of the first tension is selected from 80 N, 85 N, 90 N and 95 N. An upper limit of the first tension is selected from 80 N, 85 N, 90 N and 95 N. The first tension controls the knitted fabric to have a good radial shrinkage rate.

Optionally, the step of removing ammonia through evaporation in step 3) comprises enabling the knitted fabric to sequentially pass through a reaction unit, an evaporation unit and a steam deodorisation unit, and then, enabling the fabric to fall; and

enabling the knitted fabric to pass through a first felt cylinder of the reaction unit and a second felt cylinder of the evaporation unit,

wherein a temperature of the first felt cylinder is 70 to 110° C., and second tension of the reaction unit for controlling the knitted fabric is 54 to 67 N; and

a temperature of the second felt cylinder is 80 to 120° C., and third tension of the evaporation unit for controlling the knitted fabric is 44 to 53 N. The reaction unit and the evaporation unit of the present application are respectively made into different cavities, and their parameters can be respectively controlled. Liquid ammonia in the knitted fabric entering the reaction unit can be instantly evaporated to stop the reaction between the natural fibers and the liquid ammonia, but partial liquid ammonia will remain for continuing to react. The evaporation unit further controls to remove residual ammonia in the knitted fabric. The quantity of the residual ammonia in the knitted fabric in the evaporation unit is smaller than that of the reaction unit, the liquid ammonia may enable the knitted fabric to generate strong shrinkage, so that the tension of the first felt cylinder of the present application is set to be greater than the tension of the second felt cylinder. By using the setting mode of the temperature and the tension of the first felt cylinder and the second felt cylinder, the shrinkage rate after washing of the knitted fabric is low, and the resilience performance, the hand feeling and the stiffness performance are good.

Optionally, at least one steam drying cylinder externally coated with felt and provided with a steam hole is included in the evaporation deodorisation unit; and a downstream side of the steam deodorisation unit further comprises a drying unit, and the drying unit comprises at least one drying cylinder. By using the arrangement mode of the steam deodorisation unit, the ammonia in the knitted fabric can be further removed through the steam drying cylinder externally coated with felt and provided with a steam hole, and additionally, the steam drying cylinder treats the knitted fabric so that a drying and shaping effect is achieved.

Optionally, the method for adjusting the moisture content of the knitted fabric in step 1) comprises: enabling the knitted fabric to pass through a pre-drying unit and a cooling unit from a fabric feeding rack, wherein the knitted fabric passes through a third felt cylinder and a fourth felt cylinder of the pre-drying unit. Through the arrangement of the third felt cylinder and the fourth felt cylinder in the pre-drying unit, the knitted fabric can be dried, and additionally, the drying and shaping effect is achieved on the knitted fabric, so that the knitted fabric maintains a flat surface shape before liquid ammonia impregnation.

Optionally, a speed of the knitted fabric passing through the liquid ammonia impregnation unit liquid ammonia impregnation unit is 10 to 25 m/min. Further, a lower limit of the speed of the knitted fabric continuously passing through the liquid ammonia impregnation unit is selected from 10 m/min, 15 m/min, 20 m/min and 25 m/min, and an upper limit of the speed is selected from 10 m/min, 15 m/min, 20 m/min and 25 m/min. The speed of the liquid ammonia impregnation unit is in combination with the number of times of liquid ammonia impregnation and the control of the first tension, the liquid ammonia impregnation is uniformly performed on the knitted fabric, the obtained knitted fabric has uniform performance, low shrinkage rate, and good crease-resistant performance, resilience performance and hand feeling.

Optionally, the functional finishing further comprises a shaping and finishing procedure after the liquid ammonia finishing procedure.

A shaping agent in the shaping and finishing procedure comprises 10 to 100 g/L of a softening agent, 10 to 60 g/L of a polyurethane elastic additive, 20 to 100 g/L of resin, 4 to 30 g/L of a catalyst and 10 to 60 g/L of a fiber protecting agent.

Optionally, the shaping agent in the shaping and finishing procedure comprises 30 to 70 g/L of a softening agent, 20 to 50 g/L of a polyurethane elastic additive, 40 to 80 g/L of resin, 10 to 20 g/L of a catalyst and 20 to 45 g/L of a fiber protecting agent.

Optionally, the softening agent is selected from an ARGUS (SHANGHAI) KC-77 softening agent.

Optionally, the polyurethane elastic additive is selected from a Huntsman Corporation SI-model polyurethane elastic additive.

Optionally, the resin is selected from Huntsman Corporation RCT resin.

Optionally, the catalyst is selected from a Huntsman Corporation MO catalyst.

Optionally, the fiber protecting agent is selected from a Hongkong Advanced Chemical HI-40 fiber protecting agent.

Optionally, a shaping temperature in the shaping and finishing procedure is 160 to 200° C., and a shaping speed is 25 to 35 m/min. Preferably, the shaping temperature in the shaping and finishing procedure is 170 to 190° C., and the shaping speed is 25 to 35 m/min.

The knitted fabric after the combined treatment by the shaping and finishing procedure of the present application and the liquid ammonia procedure of the present application can basically maintain the yarn strength before treatment. Compared with those of the knitted fabric after liquid ammonia treatment, the shrinkage rate is reduced, the non-ironing performance is improved, the stiffness performance is better, the color stability after washing is high, the hairiness quantity after washing is small, and the crease-resistant performance and resilience performance are better.

Optionally, the yarns comprise dyed yarns obtained by performing a dyeing procedure on cotton yarns; dyeing raw materials used in the dyeing procedure comprise a pretreatment additive, a dyeing additive, a dye and water; and

the pretreatment additive comprises 2.5 to 3.5 g/L of a refining agent, 2.5 to 3.5 g/L of caustic soda, 4 to 8 g/L of hydrogen peroxide, 0.8 to 1.2 g/L of neutralisation acid and 0.1 to 0.3 g/L of a deoxidising enzyme.

Further, the pretreatment additive comprises 3 g/L of a refining agent, 3 g/L of caustic soda, 6 g/L of hydrogen peroxide, 1 g/L of neutralisation acid and 0.2 g/L of a deoxidising enzyme.

Optionally, the refining agent is selected from a Zibo LURAY Fine Chemicals refining agent.

Optionally, the neutralisation acid is selected from Zibo LURAY Fine Chemicals PHNLR neutralisation acid.

Optionally, the deoxidising enzyme is selected from a Zibo LURAY Fine Chemicals EZ-B type deoxidising enzyme.

Optionally, the dyeing additive comprises a chelating agent, a whitening agent and sodium sulphate.

Optionally, the chelating agent is selected from a Zibo LURAY Fine Chemicals SQBLR type chelating agent.

Optionally, the whitening agent is selected from a Zibo LURAY Fine Chemicals CE and VB type whitening agent.

Optionally, the pretreatment procedure of the dyeing procedure comprises: mixing the cotton yarns and the dyeing additive at 55 to 65° C. and then performing a reaction for 30 to 50 min at 95 to 105° C.

Preferably, the pretreatment procedure of the dyeing procedure comprises: mixing the cotton yarns and the dyeing additive at 60° C. and then performing a reaction for 40 min at 100° C.

Preferably, the pretreatment additive in the dyeing procedure comprises: 0.3 to 0.5 g/L of a chelating agent, 2.5 to 3.5 g/L of a refining agent, 2.5 to 3.5 g/L of caustic soda, 4 to 8 g/L of hydrogen peroxide, 0.8 to 1.2 g/L of neutralisation acid and 0.1 to 0.3 g/L of a deoxidising enzyme. The dyeing steps comprise: mixing 0.3% to 0.45% of the whitening agent and the hydrogen peroxide at 55 to 65° C., then, performing a reaction for 30 to 50 min at 95 to 105° C., performing a reaction for at least 3 to 8 min at 70 to 85° C., lowering the temperature to 55 to 65° C., then, adding the neutralisation acid and the deoxidising enzyme, next, raising the temperature to 50 to 60° C. and maintaining for 15 to 25 min, lowering the temperature to 40 to 55° C., then, sequentially adding the dye and the sodium sulphate, raising the temperature to 55 to 65° C. to react for 10 to 30 min, then, adding sodium carbonate and maintaining for 30 to 50 min, lowering the temperature to 45 to 55° C., performing addition for soaping, and raising the temperature to 95 to 100° C. to react for 10 to 20 min.

As an implementation, the pretreatment additive in the dyeing procedure comprises: 0.3 to 0.5 g/L of a chelating agent, 2.5 to 3.5 g/L of a refining agent, 2.5 to 3.5 g/L of caustic soda, 4 to 8 g/L of hydrogen peroxide, 0.8 to 1.2 g/L of neutralisation acid and 0.1 to 0.3 g/L of a deoxidising enzyme. The dyeing steps comprise: performing mixing at 60° C., then, performing a reaction for 40 min at 100° C., performing a reaction for 5 min at 80° C., lowering the temperature to 60° C., then, adding the neutralisation acid and the deoxidising enzyme, next, raising the temperature to 55° C. and maintaining for 20 min, lowering the temperature to 50° C., then, sequentially adding the dye and the sodium sulphate, raising the temperature to 60° C. to react for 15 min, then, adding sodium carbonate and maintaining for 40 min, lowering the temperature to 50° C., performing addition for soaping, and raising the temperature to 98° C. to react for 15 min.

According to another aspect of the present application, a liquid ammonia device used in any one of the above making methods is provided. The liquid ammonia device comprises a liquid ammonia impregnation unit. The liquid ammonia impregnation unit comprises:

a liquid ammonia tank, used for containing liquid ammonia;

a guide roller set, comprising continuously disposed guide rollers, and at least comprising a liquid ammonia roller set with a bottom surface below a liquid level of the liquid ammonia, wherein the liquid ammonia roller set is used for performing two-time liquid ammonia impregnation on the knitted fabric, and the guide roller set forms mechanical restraint on the knitted fabric; and

a roller, used for extruding liquid ammonia from the knitted fabric subjected to liquid ammonia impregnation.

Optionally, the guide roller set comprises a liquid ammonia roller set with a bottom surface below a liquid level of the liquid ammonia and a direction-guiding roller set disposed in a way of cooperating with the liquid ammonia roller set; the liquid ammonia roller set at least comprises a first liquid ammonia impregnation roller and a second liquid ammonia impregnation roller, and the liquid ammonia roller set is used for performing liquid ammonia impregnation on the knitted fabric.

Optionally, the liquid ammonia device comprises:

a fabric feeding rack, used for conveying the knitted fabric into a pre-drying unit;

the pre-drying unit, comprising a third felt cylinder and a fourth felt cylinder, wherein the knitted fabric sequentially passes through the third felt cylinder and the fourth felt cylinder to be dried;

a blow-drying unit, comprising an air producing device used for cooling the dried knitted fabric;

a liquid ammonia impregnation unit, comprising a liquid ammonia tank, a guide roller set and a roller, wherein the liquid ammonia tank is used for containing liquid ammonia; the guide roller set comprises continuously disposed guide rollers, and is disposed above the liquid ammonia tank; the guide roller set comprises a liquid ammonia roller set with a bottom surface below a liquid level of the liquid ammonia and a direction-guiding roller set disposed in a way of cooperating with the liquid ammonia roller; the liquid ammonia roller set at least comprises a first liquid ammonia impregnation roller and a second liquid ammonia impregnation roller, and the liquid ammonia roller set is used for performing two-time liquid ammonia impregnation on the knitted fabric; the direction-guiding roller set is disposed between an inlet of the liquid ammonia tank and an outlet of the liquid ammonia tank, and cooperates with the liquid ammonia roller set to form mechanical restraint on the knitted fabric; and the roller is used for extruding liquid ammonia from the knitted fabric;

a reaction unit, comprising a first felt cylinder used for further reacting and drying to remove ammonia from the knitted fabric;

an evaporation unit, comprising a second felt cylinder used for drying to remove ammonia from the knitted fabric;

a steam deodorisation unit, comprising at least one steam drying cylinder externally coated with felt and provided with a steam hole, used for removing residual ammonia steam from the knitted fabric; and

a fabric falling unit, used for outputting the knitted fabric subjected to liquid ammonia finishing.

According to further another aspect of the present application, a knitted fabric is provided, and is selected from at least one of a knitted fabric made by any one of the above methods, and/or a knitted fabric made by any one of the above liquid ammonia devices.

Optionally, the knitted fabric is a dyed knitted fabric.

Optionally, the knitted fabric is a 100% pure cotton weft knitted fabric.

According to a further another aspect of the present application, clothing is provided, and includes any one of the above knitted fabrics.

Optionally, the clothing is a business shirt, the knitted fabric is made from cotton-containing yarns with fineness being less than 30 counts through knitting, the stitch density of the knitted fabric is greater than 28 stiches/2.54 cm, and the gram weight is 90 to 200 g/cm². Further, the knitted fabric is made from cotton-containing yarns with fineness being less than 30 counts through knitting, the stitch density of the knitted fabric is greater than 30 stiches/2.54 cm, and the gram weight is 90 to 180 g/cm². Through the setting of the knitting density and the gram weight, the business shirt has good stiffness performance and high breathability.

Optionally, the knitted fabric adopts single-side knitting or double-side knitting.

Optionally, the knitted fabric is made from 100% pure cotton yarns through weft knitting, and the fineness of the pure cotton yarns is 40 to 80 counts. Further, the pure cotton weft yarns are combed cotton. The fineness of the yarns can meet the knitting density, so that the shirt has good stiffness performance, and the strength of the knitted fabric made from the yarns meets requirements.

Optionally, the knitted fabric is made from composite yarns consisting of cotton yarns and long fiber yarns through knitting, the content of the cotton yarns in the composite yarns is 20% to 80%, the fineness of the cotton yarns is 60 Ne/2 to 160 Ne/2, and the fineness of the long fiber yarns is 20 D/8f to 150 D/144f. Through the compatibility of the fineness of the cotton yarns and the fineness of the long fiber yarns, the knitted fabric has comfort elasticity and excellent strength.

Optionally, the shirt comprises a shirt main body and linings matched with the shirt main body, the shirt main body comprises the knitted fabric, and a shrinkage rate of the lining is matched with a shrinkage rate of the knitted fabric. Optionally, the lining is a 100% polyester fabric to which polyamide micelles with the granularity of 60 to 70 mesh are attached. When the shirt is made, in order to enhance the stiffness performance of the shirt, the linings are bonded to positions of cuffs, plackets and a collar of the shirt main body. When the shrinkage rates of the shirt main body and the linings are different, problems of bubbling and bulging deformation will occur after water washing. The shrinkage rate of the knitted fabric of the present application is low, so that the knitted fabric with the low shrinkage rate is made, and the shirt cannot generate the problems of bubbling and the like after being washed with water for many times.

Optionally, the shirt comprises a front piece, a rear piece and sleeves, the front piece comprises a woven fabric, and the rear piece comprises a knitted fabric. A weaving method of the woven fabric determines good stiffness performance and shape preservation performance of the woven fabric, so that the woven fabric meets the requirements of stiffness performance and shape preservation performance of shirt making. However, when the shirt is worn, good elasticity is required in arm moving parts, so that the shirt with low cost and good performance can be realised by the making method for the shirt of the present application.

The beneficial effects of the present application include, but are not limited to:

1. According to the making method for the knitted fabric containing natural fibers of the present application, in the liquid ammonia finishing procedure of the making method, liquid ammonia impregnation is performed on the knitted fabric at least twice under the condition of the mechanical restraint by the continuous guide rollers, thus preventing the knitted fabric from edge curling due to strong shrinkage in the liquid ammonia impregnation process, enabling the knitted fabric to be subjected to sufficient and uniform liquid ammonia impregnation, ensuring the liquid ammonia impregnation effect and controlling the shrinkage rate of the knitted fabric.

2. According to the making method for the knitted fabric containing natural fibers of the present application, the shrinkage rate of the knitted fabric after washing is further and effectively reduced by adjusting the tension matching of the knitted fabric at the liquid ammonia impregnation unit, the reaction unit and the evaporation unit.

3. According to the making method for the knitted fabric containing natural fibers of the present application, through the subsequent shaping and finishing procedure, the color stability of the knitted fabric is further improved, the shrinkage rate after washing is reduced, and the crease-resistant performance and resilience performance are improved.

4. According to the knitted fabric containing natural fibers of the present application, the strength of the dyed yarns of the knitted fabric can overcome the defect that the yarn strength is reduced by liquid ammonia finishing at a later stage, and the strength of the made knitted fabric is high.

5. The knitted fabric containing natural fibers according to the present application has a low shrinkage rate after washing, good stiffness performance, color stability, high strength, good crease-resistant performance, good resilience performance, small hairiness quantity and good hand feeling.

6. The clothing according to the present application has a low shrinkage rate after washing, good stiffness performance, color stability, high strength, good crease-resistant performance, good resilience performance, good wearing comfort and good hand feeling, and additionally, problems of bubbling or crease and the like cannot occur in matching parts of the shirt main body and the linings.

### BRIEF DESCRIPTION OF THE DRAWINGS

The drawings described herein are used to provide a further understanding of the present application and form a part of the present application. The schematic embodiments and descriptions of the present application are used to explain the present application and do not constitute an undue limitation on the present application. In the drawings:

FIG. 1 is a schematic diagram of a liquid ammonia device according to an embodiment of the present application.

FIG. 2 is a schematic diagram of a liquid ammonia impregnation unit of the liquid ammonia device according to an embodiment of the present application.

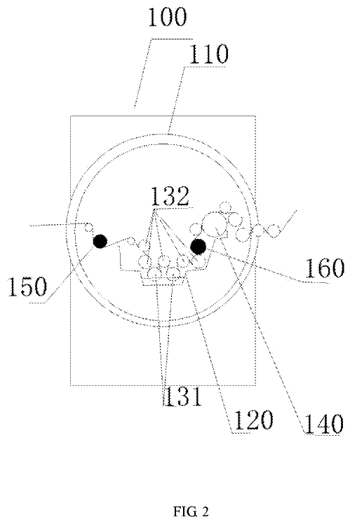

In the figures:

100 denotes a liquid ammonia impregnation unit, 110 denotes a liquid ammonia impregnation shell, 120 denotes a liquid ammonia tank, 130 denotes a guide roller set, 140 denotes a roller, 131 denotes a liquid ammonia roller set, 132 denotes a direction-guiding roller set, 150 denotes a first spreading roller, 160 denotes a second spreading roller, 200 denotes a fabric feeding rack, 300 denotes a pre-drying unit, 310 denotes a third felt cylinder, 320 denotes a fourth felt cylinder, 400 denotes a blow-drying unit, 500 denotes a reaction unit, 510 denotes a reaction shell, 520 denotes a first felt cylinder, 600 denotes an evaporation unit, 610 denotes an evaporation shell, 620 denotes a second felt cylinder, 700 denotes a steam deodorisation unit, 710 denotes a steam drying cylinder, 800 denotes a fabric falling unit, 900 denotes a drying and shaping unit, and 910 denotes a first drying cylinder.

### DETAILED DESCRIPTION OF THE INVENTION

To explain the overall conception of the present application more clearly, detailed description is conducted below in conjunction with the accompanying drawings of the specification in the form of examples.

In order to more clearly understand the above objectives, features and advantages of the present application, the present application is further described in detail in conjunction with the accompanying drawings and specific implementations. It should be noted that the embodiments of the present application and the features in the embodiments can be combined with each other if there is no conflict.

In the following description, many specific details are set forth in order to facilitate full understanding of the present application, but the present application can also be implemented in other ways other than those described herein. Therefore, the protection scope of the present application is not limited by the specific embodiments disclosed below.

Additionally, in descriptions of the present application, it should be noted that, the orientation or position relationships indicated by the terms “centre”, “upper”, “lower”, “front”, “rear”, “left”, “right”, “vertical”, “horizontal”, “top”, “bottom”, “inner”, “outer”, “axial”, “radial”, “circumferential”, etc. are based on the orientation or position relationships shown in the drawings for ease of description and simplicity of description only and are not intended to indicate or imply that the referred device or element must have a particular orientation, be constructed and operated in a particular orientation, and therefore, it cannot be construed as limiting the present application.

Additionally, terms “first” and “second” are only used for description purposes, and cannot be understood as indicating or implying relative importance or impliedly indicating the quantity of the indicated technical features. Thus, features defining “first” and “second” can explicitly or implicitly include one or more such features. In the description of the present application, “plurality” means two or more, unless specifically defined otherwise.

In the present application, unless otherwise clearly specified and defined, terms “install”, “interconnect”, “connect”, “fix”, etc. should be understood in a broad sense, for example, it can be fixed connection, detachable connection or integrated connection; it can be mechanical or electric connection, and can also be communication; it can be direct connection or indirection connection via an intermediate media; and it can be communication inside two elements or an interaction relationship between two elements. For those of ordinary skill in the art, the specific meaning of the above-mentioned terms in the present application can be understood according to specific circumstances.

In the present application, unless otherwise clearly specified and defined, the first feature “above” or “below” the second feature can be the first and second features in direct contact, or may be the first and second features in indirect contact through an intermediate media. In the description of the present application, descriptions referring to terms “one embodiment”, “some embodiments”, “examples”, “specific examples”, or “some examples”, etc., mean that particular features, structures, materials or characteristics described in conjunction with the embodiment or example are included in at least one embodiment or example of the present application. In the present application, the schematic description on the above terms is not a must of aiming at the same embodiment or example. Furthermore, the particular features, structures, materials, or characteristics described can be combined in a suitable manner in any one or more embodiments or examples.

Unless otherwise specified, raw materials, catalysts and gas in the embodiments of the present application are commercially available.

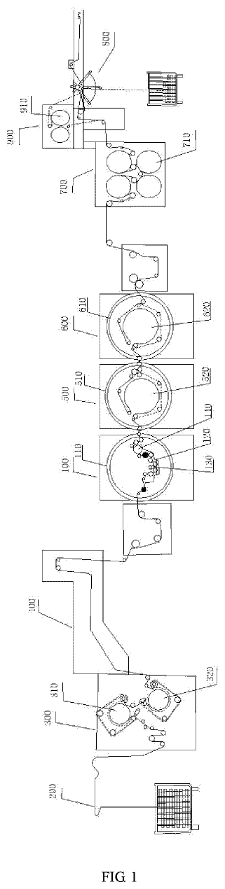

Referring to FIG. 1, a liquid ammonia device comprises a liquid ammonia impregnation unit 100. The liquid ammonia impregnation unit 100 comprises a liquid ammonia impregnation shell 110, and a liquid ammonia tank 120, a guide roller set 130 and a roller 140 disposed in a cavity formed by the liquid ammonia impregnation shell 110. Liquid ammonia is contained in the liquid ammonia tank 120. The guide roller set 130 comprises continuously disposed guide rollers. The guide roller set 130 at least comprises a liquid ammonia roller set with a bottom surface below a liquid level of the liquid ammonia. The guide roller set 130 is disposed between an inlet of the liquid ammonia tank 120 and an outlet of the liquid ammonia tank 120, and forms mechanical restraint on a knitted fabric. The roller 140 is disposed at a downstream side of the guide roller set 130, and is used for extruding liquid ammonia from the knitted fabric subjected to liquid ammonia impregnation. An liquid ammonia impregnation process of the knitted fabric is completed after the knitted fabric passes through the continuously disposed guide rollers from the inlet of the liquid ammonia tank 120, and then, the liquid ammonia in the knitted fabric is extruded at the roller 140 to reach a target ammonia content.

Preferably, at least a surface of each of the guide rollers is covered with a rubber material. By using the arrangement mode of the guide roller set 130, the ammonia quantity of the knitted fabric is uniformly controlled. The pressure of the roller 140 is set to be 70 bar to 100 bar to adjust the ammonia content of the knitted fabric, control the shrinkage rate of the knitted fabric and change the degree of the surface shape quality.

Further, the liquid ammonia device comprises a fabric feeding rack 200, a pre-drying unit 300, a blow-drying unit 400, a liquid ammonia impregnation unit 100, a reaction unit 500, an evaporation unit 600, a steam deodorisation unit 700 and a fabric falling unit. A fabric conveying path of the knitted fabric is to sequentially pass through the fabric feeding rack 200, the pre-drying unit 300, the blow-drying unit 400, the liquid ammonia impregnation unit 100, the reaction unit 500, the evaporation unit 600, the steam deodorisation unit 700 and the fabric falling unit 800. First tension of the knitted fabric at the liquid ammonia impregnation unit 100 is 75 N to 100 N.

Further, the fabric feeding rack 200 comprises two groups of spreading rollers. A centring device is disposed between the two groups of spreading rollers to solve the quality problems of edge curling, edge pressing, crease formation and the like. According to different edge curling degrees, a fabric feeding speed is set to be 200 to 400 rmp/min.

Further, the pre-drying unit 300 comprises a pre-drying shell, and a third felt cylinder 310 and a fourth felt cylinder 320 disposed in the pre-drying shell. The knitted fabric sequentially passes through the third felt cylinder 310 and the fourth felt cylinder 320 to be dried. The drying temperature is controlled to remove water. Under the coating action of felt of the third felt cylinder 310 and the fourth felt cylinder 320, the knitted fabric is reduced in warp stretching, the moisture rate of the knitted fabric is uniformly controlled, and the temperature is controlled to be 110 to 130° C.

Further, the blow-drying unit 400 comprises an air producing device used for cooling the dried knitted fabric. As the temperature of normal-pressure liquid ammonia is lower than −33.5° C., it is guaranteed that the knitted fabric enters the liquid ammonia impregnation tank in a cooled state, for preventing gasification of a great amount of liquid ammonia due to sudden rise of the temperature. The air producing device can use and comprise a motor and a fan.

Further, the guide roller set 130 comprises a liquid ammonia roller set 131 with a bottom surface below a liquid level of the liquid ammonia and a direction-guiding roller set 132 disposed in a way of cooperating with the liquid ammonia roller set 131. The liquid ammonia roller set 131 at least comprises a first liquid ammonia impregnation roller and a second liquid ammonia impregnation roller, and is used for performing liquid ammonia impregnation on the knitted fabric. The direction-guiding roller set 132 is disposed between the inlet of the liquid ammonia tank 120 and the outlet of the liquid ammonia tank 120, and cooperates with the liquid ammonia roller set 131 to form mechanical restraint on the knitted fabric. The roller 140 is used for extruding liquid ammonia from the knitted fabric.

Further, the direction-guiding roller set 132 comprises an inlet direction-guiding roller pair 133, an ammonia leaving direction-guiding roller 134 and an outlet direction-guiding roller pair 135. The knitted fabric is subjected to first-time liquid ammonia impregnation through the first liquid ammonia impregnation roller of the liquid ammonia impregnation tank after passing through the inlet direction-guiding roller pair 133, then goes out of the liquid ammonia impregnation tank through the ammonia leaving direction-guiding roller 134, is next subjected to second-time liquid ammonia impregnation through the second liquid ammonia impregnation roller, and finally finishes being subjected to the liquid ammonia impregnation after passing through the outlet direction-guiding rollers.

Further, a first spreading roller 150, a second spreading roller 160 and a third spreading roller are further disposed in the liquid ammonia impregnation shell 110. The first spreading roller 150 is disposed at an upstream side of the inlet of the liquid ammonia impregnation tank, the second spreading roller 160 is disposed at a downstream side of the outlet of the liquid ammonia impregnation tank, and the third spreading roller is disposed at a downstream side of the roller 140.

Further, the knitted fabric between the inlet of the liquid ammonia impregnation tank and the third spreading roller passes through the guide roller set 130 comprising continuously disposed guide rollers.

Further, the reaction unit 500 comprises a reaction shell 510 and a first felt cylinder 520 disposed in the reaction shell 510. The ammonia in the knitted fabric further reacts and is dried to be removed. A temperature of the first felt cylinder 520 is 70 to 110° C., and second tension of the knitted fabric of the reaction unit 500 is 54 to 67 N. The liquid ammonia sufficiently reacts with the knitted fabric, and the low tension can reduce warp stretching, so as to effectively control the shrinkage, the fabric width and the gram weight of the warp knitted fabric.

Further, the evaporation unit 600 comprises an evaporation shell 610 and a second felt cylinder 620 or a drying cylinder disposed in the evaporation shell 610. The ammonia in the knitted fabric is dried to be removed. A temperature of the second felt cylinder 620 is 80 to 120° C. Through internal temperature rise, liquid ammonia in the knitted fabric is volatilised, gasified and recovered, and third tension of the knitted fabric of the evaporation unit 600 is 44 to 53 N.

Further, the steam deodorisation unit 700 comprises at least one steam drying cylinder 710 externally coated with felt and provided with a steam hole, which is used for removing residual ammonia steam from the knitted fabric. Preferably, the steam deodorisation unit 700 comprises 4 steam drying cylinders 710 externally coated with felt and provided with steam holes. Residual ammonia flavour on the knitted fabric is removed through steam. A steam pressure is set to be 0.5 bar.

Further, the fabric falling unit 800 comprises a fabric feeding stick and a fabric arranging rack, and is used for outputting the knitted fabric after liquid ammonia finishing.

Further, the liquid ammonia device further comprises a drying and shaping unit 900 disposed behind the steam deodorisation unit 700. The drying and shaping unit 900 comprises a drying and shaping shell and at least one first drying cylinder 910, preferably two first drying cylinders 910 disposed in the drying and shaping shell.

Further, an upstream side and a downstream side of the first felt cylinder 520 in the reaction shell 510 are respectively provided with a fourth spreading roller and a fifth spreading roller. An upstream side and a downstream side of the second felt cylinder 620 in the steam shell are respectively provided with a sixth spreading roller and a seventh spreading roller.

Liquid ammonia mercerisation is completed in sealed and negative-pressure equipment. Liquid ammonia seeps into the fibers of the knitted fabric, and becomes gaseous ammonia through reaction and evaporation to be recovered into a recovery device, so as to achieve recycle and reuse, and the recycle rate reaches 95% or higher. Most liquid ammonia can be recovered and recycled for reuse, so that the environment pollution is reduced.

The liquid ammonia is used for treating the natural fiber fabric, and the natural fiber is such as cotton and linen. Compared with a woven fabric, the knitted fabric has the problems of edge curling, high shrinkage rate after washing, easy stretching deformation and poor stiffness performance. Additionally, the problems of edge curling, high shrinkage rate, easy stretching deformation and poor stiffness performance of a weft knitted fabric are more serious than those of a warp knitted fabric. A making method for a knitted fabric of the present application is illustrated hereafter by taking a weft knitted pure cotton fabric as an example.

### Embodiment 1 Dyeing of Yarns

4 kinds of 100% pure cotton combed cotton yarns 1# to 4# with different fineness were subjected to dyeing treatment. The dyeing treatment steps included:

(1) Loose type winding procedure: the yarns were wound onto a dyeing cone layer by layer to form cheese yarns with a density of 0.38 to 0.4 g/m³.

(2) Cheese yarn dyeing procedure: a technical flow process of dyeing was as follows:

2.1. Pretreatment step: 0.3 to 0.5 g/L of a chelating agent, 3 to 4 g/L of a refining agent, 3 to 4 g/L of caustic soda and 6 to 8 g/L of hydrogen peroxide were mixed at 60° C. and reacted for 40 min at 100° C.

2.2. Dyeing step: reaction was performed for 5 min at 80° C., the temperature was lowered to 55° C., then, 0.8 to 1.2 g/L of neutralisation acid and 0.1 to 0.2 g/L of a deoxidising enzyme were added, next, the temperature was raised to 55° C. and maintained for 20 min, the temperature was lowered to 50° C., and then, 3% to 5% of a dye and 10 to 20 g/L of sodium sulphate were sequentially added, the temperature was raised to 60° C. for reaction for 15 min, then, sodium carbonate was added and maintained for 40 min, the temperature was lowered to 50° C., addition was performed for soaping, and the temperature was raised to 98° C. for reaction for 15 min.

(3) Knitting procedure: the dyed yarns were knitted on a knitting machine according to preset process parameters and designed patterns.

The 4 kinds of 100% pure cotton combed cotton yarns 1# to 4# with different fineness were respectively dyed according to the above making method, the tension of the yarns before and after the dyeing was tested, and the results are as shown in Table 1.

TABLE 1

| | Original yarn | Strength after | Strength reduction |
|---|---|---|---|
| Sequence number | strength | dyeing | rate |
| Yarn 1 | 348.5 | 330.5 | 5.16% |
| Yarn 2 | 356.3 | 345.3 | 3.09% |
| Yarn 3 | 386.2 | 376.3 | 2.56% |
| Yarn 4 | 330.1 | 308.8 | 6.45% |
| Average | 355.275 | 340.225 | 4.24% |

### Comparative Example 1 Dyeing of Comparative Yarns

The 4 kinds of 100% pure cotton combed cotton yarns 1# to 4# with different fineness were respectively subjected to dyeing treatment according to the dyeing method of Embodiment 1 to make yarns 1# to 4#. The difference was that ingredients of the pretreatment additive and the pretreatment steps were different. The pretreatment additive in the dyeing method of the comparative yarns included: 4 g/L of a refining agent, 4 g/L of caustic soda and 10 g/L of hydrogen peroxide. The dyeing pretreatment steps of the comparative yarns 1# to 4# included: mixing 0.3 to 0.5 g/L of a chelating agent, 4 g/L of a refining agent, 4 g/L of caustic soda, 0.3% to 0.45% of a whitening agent and 10 g/L of hydrogen peroxide at 50° C., and then performing reaction for 40 min at 110° C.

The 4 kinds of 100% pure cotton combed cotton yarns with different fineness were respectively dyed by different dyeing methods according to the above making method to obtain the comparative yarns 1# to 4#, the strength of the yarns before and after the dyeing was tested, and the results were as shown in Table 2.

TABLE 2

| | Original yarn | Strength after | Strength reduction |
|---|---|---|---|
| Sequence number | strength | dyeing | rate |
| Comparative yarn 1 | 358 | 258 | 27.93% |
| Comparative yarn 2 | 386.3 | 264 | 31.66% |
| Comparative yarn 3 | 403.5 | 346 | 14.25% |
| Comparative yarn 4 | 348.5 | 300.3 | 13.83% |
| Average | 374.075 | 292.075 | 21.92% |

Through results of Comparative example 1 and Embodiment 1, it could be known that in Embodiment 1, the consumption of the pretreatment additive was low, the energy consumption was low, and the yarn strength reduction amount was small.

### Embodiment 2 Liquid Ammonia Finishing

A pure cotton knitted fabric 1# obtained by performing weft knitting on 75-count 100% combed cotton yarns subjected to dyeing treatment in Embodiment 1 was subjected to functional finishing including a liquid ammonia finishing procedure, the speed of the liquid ammonia finishing procedure was 10 to 25 m/min, the surfaces of the guide rollers were made of rubber materials, and the procedure included the following steps:

1) A moisture content of the knitted fabric was adjusted to be below 10%.

2) The knitted fabric obtained in step 1) was subjected to two-time liquid ammonia impregnation in the liquid ammonia impregnation tank through the guide roller set 130, the liquid ammonia impregnation quantity was controlled to be 30% to 70% of the dry weight of the knitted fabric, and a impregnation pressure was 70 bar to 100 bar.

3) The knitted fabric obtained in step 2) passed through the first felt cylinder of the reaction unit at the temperature of 90 to 110° C., and the second tension was 54 to 67 N.

4) The knitted fabric obtained in step 3) passed through the second felt cylinder of the evaporation unit at the temperature of 80 to 120° C., and the third tension was 44 to 53 N.

5) The knitted fabric obtained in step 4) passed through the steam deodorisation unit and was dried to obtain pure cotton knitted fabrics 1# to 5#.

The specific liquid ammonia treatment parameters and the test structures of the pure cotton knitted fabrics 1# to 4# and comparative pure cotton knitted fabrics D1# to D4# were as shown in Table 3. A test method of breathability (mm/s) conformed to GB/T 5453. A test method of the water washing size change rate (%) was ISO 6330. The non-ironing performance (grade) test conformed to the standard AATCC124. The elasticity/recovery/residual (%) test conformed to the standard ASTMD 3107. The test method of the bursting strength (N) included GB/T 19976.

TABLE 3

| | | | | | water washing size change |
|---|---|---|---|---|---|
| Serial number | Operating conditions | Gram weight/g/m² | Water absorption performance/s | Breathability/s | rate/% |
| Pure cotton | The speed was 15 m/min; the | 145 | 4 | 105 | −3.1 |
| knitted | liquid ammonia impregnation | | | | |
| fabric 1# | quantity was 65% of the dry | | | | |
| | weight of the knitted fabric; | | | | |
| | the temperature of the first | | | | |
| | felt cylinder was 90° C., and | | | | |
| | the second tension was 60N; and | | | | |
| | the temperature of the second | | | | |
| | felt cylinder was 100° C., and | | | | |
| | the third tension was 50N. | | | | |
| Pure cotton | The speed was 20 m/min; the | 150 | 3 | 116 | −2.8 |
| knitted | liquid ammonia impregnation | | | | |
| fabric2# | quantity was 60% of the dry | | | | |
| | weight of the knitted fabric; | | | | |
| | the temperature of the first | | | | |
| | felt cylinder was 95° C., and | | | | |
| | the second tension was 58N; and | | | | |
| | the temperature of the second | | | | |
| | felt cylinder was 110° C., and | | | | |
| | the third tension was 48N. | | | | |
| Pure cotton | The speed was 10 m/min; the | 148 | 5 | 96 | −3.5 |
| knitted | liquid ammonia impregnation | | | | |
| fabric 3# | quantity was 68% of the dry | | | | |
| | weight of the knitted fabric; | | | | |
| | the temperature of the first | | | | |
| | felt cylinder was 70° C., and | | | | |
| | the second tension was 54N; and | | | | |
| | the temperature of the second | | | | |
| | felt cylinder was 80° C., and | | | | |
| | the third tension was 44N. | | | | |
| Pure cotton | The speed was 25 m/min; the | 140 | 8 | 110 | −3.5 |
| knitted | liquid ammonia impregnation | | | | |
| fabric 4# | quantity was 57% of the dry | | | | |
| | weight of the knitted fabric; | | | | |
| | the temperature of the first | | | | |
| | felt cylinder was 100° C., and | | | | |
| | the second tension was 67N; and | | | | |
| | the temperature of the second | | | | |
| | felt cylinder was 120° C., and | | | | |
| | the third tension was 53N. | | | | |
| Comparative | The speed was 27 m/min; the | 140 | 10 | 96 | −3.3 |
| pure cotton | liquid ammonia impregnation | | | | |
| knitted | quantity was 57% of the dry | | | | |
| fabric D1# | weight of the knitted fabric; | | | | |
| | the temperature of the first | | | | |
| | felt cylinder was 95° C., and | | | | |
| | the second tension was 60N; and | | | | |
| | the temperature of the second | | | | |
| | felt cylinder was 100° C., and | | | | |
| | the third tension was 50N. | | | | |
| Comparative | The speed was 15 m/min; the | 142 | 5 | 108 | −3.0 |
| pure cotton | liquid ammonia impregnation | | | | |
| knitted | quantity was 65% of the dry | | | | |
| fabric D2# | weight of the knitted fabric; | | | | |
| | the temperature of the first | | | | |
| | felt cylinder was 90° C., and | | | | |
| | the second tension was 60N; and | | | | |
| | the temperature of the second | | | | |
| | felt cylinder was 100° C., and | | | | |
| | the third tension was 60N. | | | | |
| Comparative | First-time liquid ammonia | 138 | 10 | 90 | −4 |
| pure cotton | impregnation | | | | |
| knitted | | | | | |
| fabric D3# | | | | | |
| Comparative | The surface of the guide roller | 142 | 8 | 98 | −3.5 |
| pure cotton | is made of a steel material | | | | |
| knitted | | | | | |
| fabric D4# | | | | | |

| | | | | | Soaping-resistant |
|---|---|---|---|---|---|
| Serial number | Non-ironing performance/% | Ironing shrinkage rate/% | Bursting strength/N | Elasticity/recovery/residual/% | color fastness/grade |
| Pure cotton | 3.3 | 1.5 | 658 | 18/65/12 | 4 |
| knitted | | | | | |
| fabric 1# | | | | | |
| Pure cotton | 3.4 | 1.2 | 720 | 24/68/10 | 4 |
| knitted | | | | | |
| fabric2# | | | | | |
| Pure cotton | 3.2 | 1.5 | 650 | 20/65/13 | 4 |
| knitted | | | | | |
| fabric 3# | | | | | |
| Pure cotton | 3.1 | 1.3 | 615 | 21/66/18 | 4 |
| knitted | | | | | |
| fabric 4# | | | | | |
| Comparative | 3.0 | 1.6 | 560 | 20/59/20 | 4 |
| pure cotton | | | | | |
| knitted | | | | | |
| fabric D1# | | | | | |
| Comparative | 3.2 | 1.2 | 595 | 25/66/18 | 4 |
| pure cotton | | | | | |
| knitted | | | | | |
| fabric D2# | | | | | |
| Comparative | 3.0 | 1.8 | 586 | 22/60/16 | 4 |
| pure cotton | | | | | |
| knitted | | | | | |
| fabric D3# | | | | | |
| Comparative | 3.1 | 2 | 601 | 18/66/10 | 4 |
| pure cotton | | | | | |
| knitted | | | | | |
| fabric D4# | | | | | |

The treatment effect of liquid ammonia treatment on natural fabrics such as cotton and linen fabrics is obvious. Good “easy-sorting” and “brand-new appearance” characteristics, good crease-resistant performance, high fabric surface smoothness, high color saturation, improvement of tensile strength, tear strength and abrasion resistance, full hand feeling, softness, high elasticity, small shrinkage, size stability after multi-time washing, and rough and itching feeling avoidance of the linen fabric are achieved.

### Embodiment 3 Shaping and Finishing

The made pure cotton knitted fabric 1# of Embodiment 2 was treated by a shaping and finishing procedure to respectively obtain pure cotton knitted fabrics 5# to 8#, and comparative pure cotton knitted fabrics D5# to D7#. The shaping temperature of the shaping and finishing procedure was 160 to 200° C., and the shaping speed was 25 to 35 m/min.

A shaping agent included: 10 to 100 g/L of an ARGUS (SHANGHAI) KC-77 softening agent, 10 to 60 g/L of a Huntsman Corporation SI-model polyurethane elastic additive, 20 to 100 g/L of Huntsman Corporation RCT resin, 4 to 30 g/L of a Huntsman Corporation MO catalyst and 10 to 60 g/L of a Hongkong Advanced Chemical HI-40 fiber protecting agent.

The specific parameters of the shaping and finishing procedure and the test structures of the pure cotton knitted fabrics 5# to 7# and comparative pure cotton knitted fabrics D5# to D7# were as shown in Table 4. A test method of breathability (mm/s) conformed to GB/T 5453. A test method of the water washing size change rate (%) was ISO 6330. The non-ironing performance (grade) test conformed to the standard AATCC124. The elasticity/recovery/residual (%) test conformed to the standard ASTMD 3107. The test method of the bursting strength (N) included GB/T 19976.

TABLE 4

| | | | | | | | | Soaping- |
|---|---|---|---|---|---|---|---|---|
| | | | Water washing | | Ironing | | Elasticity/ | resistant |
| Serial | | Gram | size change | Non-ironing | shrinkage | Bursting | recovery/ | color fast- |
| number | Operating conditions | weight/g/m² | rate/% | performance/% | rate/% | strength/N | residual/% | ness/grade |
| Pure cotton | The shaping temperature was | 145 | −2.5 | 3.3 | −0.9 | 510 | 20/65/13 | 4 |
| knitted | 180° C., and the shaping speed | | | | | | | |
| fabric 5# | was 30 m/min. The shaping agent | | | | | | | |
| | included: 50 g/L of a softening | | | | | | | |
| | agent, 30 g/L of a polyurethane | | | | | | | |
| | elastic additive, 60 g/L of | | | | | | | |
| | resin, 17 g/L of a catalyst and | | | | | | | |
| | 30 g/L of a fiber protecting | | | | | | | |
| | agent. | | | | | | | |
| Pure cotton | The shaping temperature was | 142 | −2.6 | 3.2 | −1.2 | 560 | 22/66/11 | 4 |
| knitted | 160° C., and the shaping speed | | | | | | | |
| fabric 6# | was 25 m/min. The shaping agent | | | | | | | |
| | included: 10 g/L of a softening | | | | | | | |
| | agent, 10 g/L of a polyurethane | | | | | | | |
| | elastic additive, 20 g/L of | | | | | | | |
| | resin, 4 g/L of a catalyst and | | | | | | | |
| | 10 g/L of a fiber protecting | | | | | | | |
| | agent. | | | | | | | |
| Pure cotton | The shaping temperature was | 140 | −2.2 | 3.5 | −0.8 | 480 | 25/70/16 | 4 |
| knitted | 200° C., and the shaping speed | | | | | | | |
| fabric 7# | was 30 m/min. The shaping agent | | | | | | | |
| | included: 100 g/L of a | | | | | | | |
| | softening agent, 60 g/L of a | | | | | | | |
| | polyurethane elastic additive, | | | | | | | |
| | 100 g/L of resin, 30 g/L of a | | | | | | | |
| | catalyst and 60 g/L of a fiber | | | | | | | |
| | protecting agent. | | | | | | | |
| Comparative | The shaping temperature was | 143 | −2.8 | 3.3 | −1.2 | 540 | 19/68/12 | 4 |
| pure cotton | 150° C., and the shaping speed | | | | | | | |
| knitted | was 25 m/min. The shaping agent | | | | | | | |
| fabric D1# | included: 120 g/L of a | | | | | | | |
| | softening agent, 10 g/L of a | | | | | | | |
| | polyurethane elastic additive, | | | | | | | |
| | 120 g/L of resin, 35 g/L of a | | | | | | | |
| | catalyst and 70 g/L of a fiber | | | | | | | |
| | protecting agent. | | | | | | | |

The made knitted fabric of the present embodiment had good hand feeling stiffness performance and drapability, good water absorption performance, high breathability, high bursting strength, more stable shrinkage rate after washing, and small color and hairiness change after washing, and the crease-resistant performance and the elasticity of the fabric were improved.

### Embodiment 4 Clothing Making

A making process of a shirt is illustrated by using a shirt made by a pure cotton knitted fabric 5# as an example. The shirt included a shirt main body made from the pure cotton knitted fabric 5# and linings bonded to the shirt main body. The shrinkage rate of the pure cotton knitted fabric 5# was within −3%, the lining fabrics used 100% polyester to which 66-mesh polyamide micelles were attached, and the made shirt did not have problems of bulging, bubbling and the like after being washed with water for 100 times.

The above is only the embodiments of the present application, and the protection scope of the present application is not limited by these specific embodiments, but is determined by the claims of the present application. For those skilled in the art, the present application can have various modifications and changes. Any modification, equivalent replacement, improvement, etc. made within the technical ideas and principles of the present application shall be included in the protection scope of the present application.

1-30. (canceled)

31. A making method for a knitted fabric containing natural fibers, characterized by comprising:
forming yarns containing natural fibers into a knitted fabric by a fabric-knitting method, and performing functional finishing including a liquid ammonia finishing procedure on the knitted fabric, wherein the liquid ammonia finishing procedure comprises:
1) adjusting a moisture content of the knitted fabric to be below 10%;
2) performing liquid ammonia impregnation on the knitted fabric obtained in step 1) at least twice in a liquid ammonia impregnation tank through a guide roller set, enabling the knitted fabric to maintain mechanical restraint at least between an inlet of the liquid ammonia impregnation tank and an outlet of the liquid ammonia impregnation tank, enabling the knitted fabric finishing being subjected to liquid ammonia impregnation to pass through a roller to extrude excessive ammonia from the knitted fabric, and controlling the liquid ammonia impregnation quantity to be 45% to 75% of the dry weight of the knitted fabric; and
3) removing ammonia from the knitted fabric obtained in step 2) through evaporation to obtain the knitted fabric;
wherein the guide roller set is disposed between the inlet of the liquid ammonia impregnation tank and the outlet of the liquid ammonia impregnation tank;
the guide roller set comprises continuously disposed guide rollers; and
at least a surface of the guide roller is made of an elastic material;
the step of removing ammonia through evaporation in step 3) comprises enabling the knitted fabric to sequentially pass through a reaction unit, an evaporation unit and a steam deodorisation unit, and then, enabling the fabric to fall; and
enabling the knitted fabric to pass through a first felt cylinder of the reaction unit and a second felt cylinder of the evaporation unit,
wherein a temperature of the first felt cylinder is 70 to 110° C., and second tension of the reaction unit for controlling the knitted fabric is 54 to 67 N; and
a temperature of the second felt cylinder is 80 to 120° C., and third tension of the evaporation unit for controlling the knitted fabric is 44 to 53 N;
the radial tension of the knitted fabric passing through the liquid ammonia impregnation tank and the roller is set to be first tension, and the first tension is 75 N to 100 N; and
a speed of the knitted fabric continuously passing through a liquid ammonia impregnation unit is 15 to 25 m/min.

32. The making method according to claim 31, characterized in that a first spreading roller is disposed at an upstream side of the inlet of the liquid ammonia impregnation tank,
a second spreading roller is disposed at a downstream side of the outlet of the liquid ammonia impregnation tank, and/or
a third spreading roller is disposed at a downstream side of the roller.

33. The making method according to claim 32, characterized in that at least the knitted fabric between the inlet of the liquid ammonia impregnation tank and the third spreading roller passes through the guide roller set; and
the guide roller set comprises continuously disposed guide rollers.

34. The making method according to claim 31, characterized in that the guide roller set comprises a direction-guiding roller set and a liquid ammonia impregnation roller set disposed between the inlet of the liquid ammonia impregnation tank and the outlet of the liquid ammonia impregnation tank;
the direction-guiding roller set comprises an inlet direction-guiding roller pair, an ammonia leaving direction-guiding roller and an outlet direction-guiding roller pair;
the liquid ammonia impregnation roller set comprises a first liquid ammonia impregnation roller and a second liquid ammonia impregnation roller; and
the knitted fabric is subjected to first-time liquid ammonia impregnation through the first liquid ammonia impregnation roller of the liquid ammonia impregnation tank after passing through the inlet direction-guiding roller pair, then goes out of the liquid ammonia impregnation tank through the ammonia leaving direction-guiding roller, is next subjected to second-time liquid ammonia impregnation through the second liquid ammonia impregnation roller, and finally finishes being subjected to the liquid ammonia impregnation after passing through the outlet direction-guiding rollers.

35. (canceled)

36. (canceled)

37. The making method according to claim 31, characterized in that the method for adjusting the moisture content of the knitted fabric in step 1) comprises:
enabling the knitted fabric to pass through a pre-drying unit and a cooling unit from a fabric feeding rack,
wherein the knitted fabric passes through a third felt cylinder and a fourth felt cylinder of the pre-drying unit.

38. (canceled)

39. The making method according to claim 31, characterized in that the functional finishing further comprises a shaping and finishing procedure after the liquid ammonia finishing procedure, and
a shaping agent in the shaping and finishing procedure comprises 10 to 100 g/L of a softening agent, 10 to 60 g/L of a polyurethane elastic additive, 20 to 100 g/L of resin, 4 to 30 g/L of a catalyst and 10 to 60 g/L of a fiber protecting agent; and
a shaping temperature in the shaping and finishing procedure is 160 to 200° C., and a shaping speed is 25 to 35 m/min.

40. The making method according to claim 31, characterized in that the yarns comprise dyed yarns obtained by performing a dyeing procedure on cotton yarns;
dyeing raw materials used in the dyeing procedure comprise a pretreatment additive, a dyeing additive, a dye and water; and
the pretreatment additive comprises 2.5 to 3.5 g/L of a refining agent, 2.5 to 3.5 g/L of caustic soda, 4 to 8 g/L of hydrogen peroxide, 0.8 to 1.2 g/L of neutralisation acid and 0.1 to 0.3 g/L of a deoxidising enzyme.

41. The making method according to claim 40, characterized in that the pretreatment procedure of the dyeing procedure comprises mixing the cotton yarns and the dyeing additive at 55 to 60° C. and then performing a reaction for 40 min at 95 to 105° C.

42. A knitted fabric, characterized by being selected from:
at least one of a knitted fabric made by the method according to claim 31.

43. The knitted fabric according to claim 42, characterized in that the knitted fabric is a dyed knitted fabric; and/or the knitted fabric is a 100% pure cotton weft knitted fabric.

44. Clothing, characterized by comprising the knitted fabric according to claim 42.

45. The clothing according to claim 44, characterized in that the clothing is a business shirt, the knitted fabric is made from cotton-containing yarns with fineness being less than 30 counts through knitting, the stitch density of the knitted fabric is greater than 28 stiches/2.54 cm, and the gram weight is 90 to 200 g/cm².

46. The clothing according to claim 45, characterized in that the knitted fabric is made from 100% pure cotton yarns through weft knitting, and the fineness of the pure cotton yarns is 40 to 80 counts.

47. The clothing according to claim 45, characterized in that the knitted fabric is made from composite yarns consisting of cotton yarns and long fiber yarns through knitting, the content of the cotton yarns in the composite yarns is 20% to 80%, the fineness of the cotton yarns is 60 Ne/2 to 160 Ne/2, and the fineness of the long fiber yarns is 20 D/8f to 150 D/144f.

48. The clothing according to claim 44, characterized in that the shirt comprises a shirt main body and linings matched with the shirt main body, the shirt main body comprises the knitted fabric, and the shrinkage rate of the lining is matched with a shrinkage rate of the knitted fabric.

49. The clothing according to claim 48, characterized in that the lining is a 100% polyester fabric to which polyamide micelles with the granularity of 60 to 70 mesh are attached.

50. The clothing according to claim 45, characterized in that the shirt comprises a front piece, a rear piece and sleeves, wherein the front piece comprises a woven fabric, and the rear piece comprises a knitted fabric.
